(19) United States
(12) Patent Application Publication
(10) Pub. No.: US 2018/0099413 A1
(43) Pub. Date: Apr. 12, 2018

(54) ROBOT SYSTEM AND MAINTENANCE METHOD FOR TRACKING INFORMATION OF MODULE

(71) Applicant: FANUC CORPORATION, Yamanashi (JP)

(72) Inventors: Yasuhiro Naitou, Yamanashi (JP); Kiyoshi Yoshino, Yamanashi (JP)

(73) Assignee: FANUC CORPORATION, Yamanashi (JP)

(21) Appl. No.: 15/728,709

(22) Filed: Oct. 10, 2017

(30) Foreign Application Priority Data
Oct. 12, 2016 (JP) 2016-200975

(51) Int. Cl. B25J 9/16

(52) U.S. Cl. CPC B25J 9/1682; G05B 2219/33285; G05B 2219/39412; B25J 9/1674

(57) ABSTRACT

A robot system and a maintenance method, capable of easily managing maintenance information and/or predicting a failure, with respect to each module constituting a robot. The robot system includes a plurality of robots each having an arm configured as an exchangeable module. The robot system also includes: a robot information storing section configured to store robot information including at least one of an operational status, failure prediction information, failure diagnosis information and maintenance history information of each module; a reading section configured to read a unique identifiable information of the module; a robot information referring section configured to refer to the stored robot information with respect to the module corresponding to the read unique identifiable information; and a robot information outputting section configured to output the robot information with respect to each module of the robot.

### BACKGROUND OF THE INVENTION

### 1. Field of the Invention

The preset invention relates to a robot system and a maintenance method for tracking information of a module constituting a robot, by which the robot can be managed and a failure of the robot can be predicted.

### 2. Description of the Related Art

In some types of industrial robots, a part of a mechanical unit constituting the robot can be exchangeable as one unit (or module). As a relevant prior art document, JP 2004-148433 A discloses a robot device, in which various data after a robot mechanical unit is exchanged can be automatically changed.

On the other hand, a technique to diagnose or predict a failure or malfunction of a component of a robot is well-known (for example, JP 2004-202624 A, JP 2015-217468 A or JP H07-107767 A). Further, a technique to obtain operational information of each component of a robot and store the information into a database is well-known (for example, JP 2007-260834 A, JP 2014-050951 A or JP 2013-218408 A).

When the robot mechanical unit is modularized, each module may be attached to or detached from the robot as required. However, in the prior art, it is difficult to collect maintenance information or correctly predict the failure with respect to each component. For example, when a modularized arm attached to one robot is removed and attached to another robot, or when one modularized arm attached to a robot is removed and another modularized arm is attached to the robot, a malfunction or failure of the newly attached arm cannot be predicted.

In the technique of JP 2004-148433 A, a parameter (such as a D-H parameter) required for calculating of trajectory control for the robot is stored a memory attached to each mechanical unit of the robot, and then, the information stored in the memory is automatically read by a controller, after a part or all of the mechanical units is exchanged, by which the trajectory control of a robot program can be realized without calibrating the mechanical unit of the robot, similarly to the control before exchanging the mechanical unit. However, neither the prediction of the failure nor the management of maintenance information of each component of the robot is carried out in the technique of JP 2004-148433 A.

The technique of JP 2004-202624 A, JP 2015-217468 A or JP H07-107767 A is intended to diagnose or predict a failure of the component of the robot, whereas a period of time regarding the information required therefor is limited to when the objective component is attached to a specified robot. Therefore, if the component is detached from one robot and then attached to the other robot, it is difficult to appropriately diagnose or predict a failure.

On the other hand, the technique JP 2007-260834 A, JP 2014-050951 A or JP 2013-218408 A is intended to store the operational information such as an accumulated operation time with respect to each component, and utilize the stored information for determining a time point of exchanging the component, etc. However, a period of time regarding the information required therefor is also limited to when the objective component is attached to a specified robot.

### SUMMARY OF THE INVENTION

Therefore, an object of the present invention is to provide a robot system and a maintenance method, capable of easily managing maintenance information and/or predicting a failure, with respect to each module constituting a robot.

One aspect of the present invention provides a robot system, comprising: a robot mechanical unit constituted by a plurality of modules, each module having a unique identifiable information and being exchangeable; a robot controller configured to control a motion of each axis of the robot mechanical unit; a robot information storing section configured to store robot information including at least one of an operational status, failure prediction information, failure diagnosis information and maintenance history information of each module; a reading section configured to read the unique identifiable information of the module; a robot information referring section configured to refer to the stored robot information with respect to the module corresponding to the read unique identifiable information; and a robot information outputting section configured to output the robot information with respect to each module of the robot mechanical unit.

The robot information storing section may be included in a database connected to a communication network connected to the robot system. Alternatively, the robot information storing section may be included in a database provided to the robot controller. Alternatively, the robot information storing section may be included in a database provided to a non-volatile memory provided to each module of the robot mechanical unit.

It is preferable that the robot information provided to each module of the robot mechanical unit be accumulated information of the module with respect to all of robots to which the module is presently attached and was attached in the past.

In a preferred embodiment, the robot information outputting section is a display device provided or connected to the robot controller.

Another aspect of the present invention provides a maintenance method for a robot system, the robot system including: a robot mechanical unit constituted by a plurality of modules, each module having a unique identifiable information and being exchangeable; and a robot controller configured to control a motion of each axis of the robot mechanical unit, wherein the method comprising the steps of: storing robot information including at least one of an operational status, failure prediction information, failure diagnosis information and maintenance history information of each module; reading the unique identifiable information of the module; referring to the stored robot information with respect to the module corresponding to the read unique identifiable information; and outputting the robot information with respect to each module of the robot mechanical unit.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 shows a schematic configuration of a robot system according to a preferred embodiment of the present invention;

FIG. 2 is a block diagram of a robot controller of FIG. 1;

FIG. 3 is a block diagram of a database of FIG. 1;

FIG. 4 is a flowchart showing an example of a procedure in the robot system of FIG. 1;

FIG. 5 is shows an example, in which a part of modules (arms) is replaced with another in the robot system of FIG. 1; and

FIG. 6 is a block diagram of a robot controller including a database.

### DETAILED DESCRIPTIONS

Hereinafter, a preferred embodiment of the present invention will be explained with reference to the drawings. In working examples as explained below, an arm component (robot arm) is exemplified as an exchangeable module provided to a robot mechanical unit. However, the other exchangeable module, such as a speed reducer or a motor, or a combination thereof (or unit components) may be used as the module, as long as at least one of an operational status, failure prediction information, failure diagnosis information and maintenance history information (hereinafter, also referred to as “robot information”) of each module can be obtained.

### Working Example 1

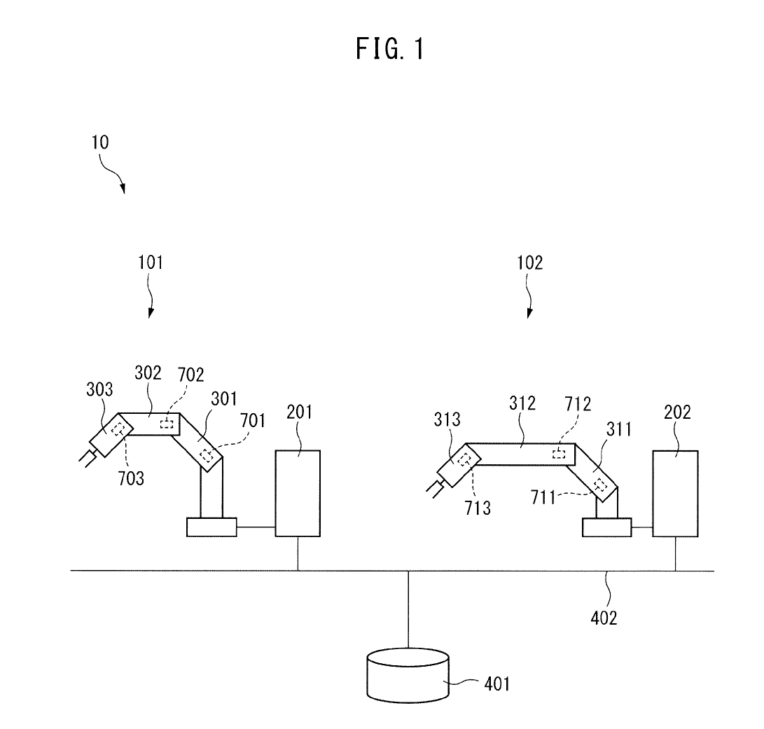

FIG. 1 shows a schematic configuration of a robot system 10 according to a first working example of the present invention. Robot system 10 includes at least one (preferably, a plurality of) robot mechanical unit (hereinafter, also referred to as merely “robot”) (in this example, two robots 101 and 102), and robot controllers 201 and 202 configured to control the motion of each axis of robots 101 and 102, respectively. Robot controllers 201 and 202 are connected to each other via a communication network 402 connected to robot system 10, and are also connected to a database 401.

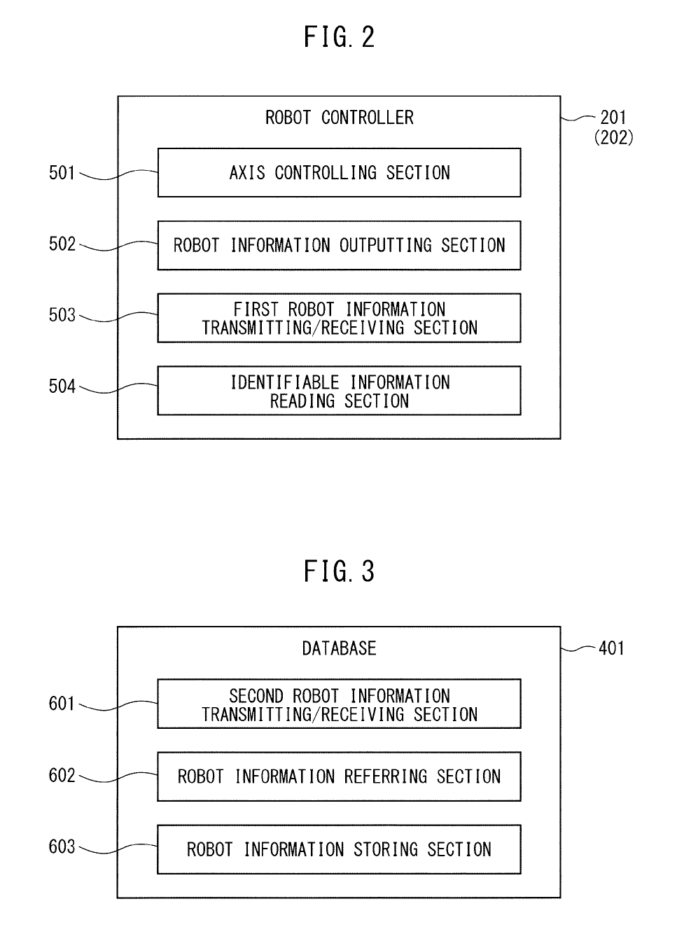

FIG. 2 is a block diagram of robot controller 201 (or 202). Robot controller 201 (202) has: an axis controlling section 501 configured to control the motion of each axis of robot 101 (102); a robot information outputting section 502 configured to output the robot information; a first robot information transmitting/receiving section 503 configured to transmit/receive the robot information via communication network 402; and an identifiable information reading section 504 configured to read identifiable information which is unique to each module. In this regard, reading section 504 may be provided to another device such as a computer (not shown), other than the robot controller, which is connected to database 401. Otherwise, reading section 504 may be provided to both the robot controller and the computer.

As axis controlling section 501, first robot information transmitting/receiving section 503 and/or reading section 504, a central processing unit (CPU), a communication module, a memory and various sensors, and a combination thereof may be used. Further, a means for providing the robot information to the operator can be used as robot information outputting section 502. For example, a means for giving a sound regarding the robot information to the operator, or a means for transmitting the robot information to another device (not shown) which the operator can access, as well as the display or monitor by which the operator can visually know the robot information, may be used as robot information outputting section 502. In addition, as shown in FIG. 2, it is preferable that displaying section (or information outputting section) 502 be contained in the robot controller or be a display device connected to the robot controller.

FIG. 3 is a block diagram of database 401. Database 401 has: a second robot information transmitting/receiving section 601 configured to communicate with first robot information transmitting/receiving section 503; a robot information referring section 602 configured to refer to the robot information associated with the identifiable information which has been read; and a robot information storing section 603 configured to store the robot information received by second robot information transmitting/receiving section 601. For example, as second robot information transmitting/receiving section 601, robot information referring section 602 and/or robot information storing section 603, a central processing unit (CPU), a communication module and a memory, or a combination thereof may be used.

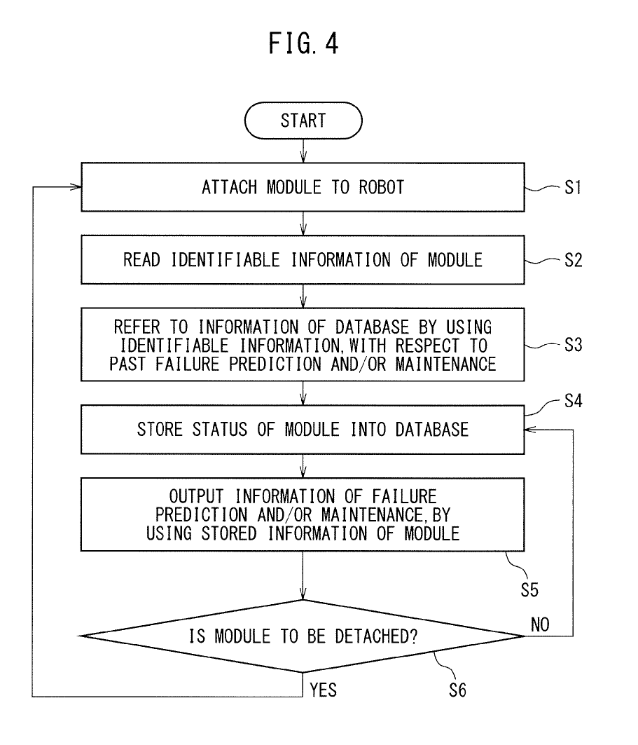

Hereinafter, the procedure (maintenance method) in robot system 10 will be explained, with reference to a flowchart of FIG. 4. First, in step S1, exchangeable modules are respectively attached to robots 101 and 102. In the first working example, as shown in FIG. 1, robot 101 is a multi-joint robot having arms (or exchangeable modules) 301, 302 and 303, and robot 102 is a multi-joint robot having arms (or exchangeable modules) 311, 312 and 313.

In the next step S2, identifiable information of each module is read. For example, an identifiable number represented by a character string printed on a surface of the arm attached to robot 101 (102) may be detected by a vision sensor or the operator, the read identifiable number may be input robot controller 201 (202), and then the identifiable number may be read by identifiable information reading section 504.

A type of the identifiable number is not limited to the character string as explained above. For example, a barcode or two-dimensional code representing the identifiable number may be adhered to the arm surface, otherwise, a non-volatile memory electrically storing the identifiable number may be contained in the arm. As described below, the identifiable number is used to associate each module with the information stored in database 401.

In the next step S3, robot information referring section 602 configured to refers to the information regarding failure prediction and/or maintenance history in the past of each module from database 401, corresponding to the read identifiable information. Then, in step S4, the status (an operation result, etc.) of each module is stored in database 401. In this regard, robot controller 201 transmits the robot information of arms 301, 302 and 303 to database 401 by using first robot information transmitting/receiving section 503, and similarly, robot controller 202 transmits the robot information of arms 311, 312 and 313 to database 401 by using first robot information transmitting/receiving section 503. Then, robot information storing section 603 of database 401 stores or accumulates the received robot information with respect to (each identifiable number of) each module. In addition, the execution order of steps S3 and S4 may be reversed.

In the next step S5, by using the information of each arm (module) stored in database 401, the robot information is output (or provided to the operator) with respect to each arm. For example, the robot information of each module may be provided or output by being displayed on the displaying section of the robot controller. The robot information may also be noticed by sound or transmitted to the other device as data.

Table 1 shows an example of the content displayed in a tabular form on robot controller 201. It is preferable that the output robot information of each module be stored or accumulated with respect to all of the robots to which the corresponding module is presently attached or was attached in the past.

TABLE 1

| | | Failure | Failure | Maintenance |
|---|---|---|---|---|
| Name of | Operational | Prediction | Diagnosis | History |
| Module | Status | Information | Information | Information |
| Arm 301 | 500 hours/month | Failure is | Normal | Component |
| | | not predicted | | A was |
| | | | | exchanged |
| | | | | on ZZ/ |
| | | | | YY/20XX |
| Arm 302 | 500 hours/month | Failure is | Normal | No |
| | | not predicted | | Maintenance |
| | | | | History |
| Arm 303 | 600 hours/month | Failure will | Normal | No |
| | | occur within | | Maintenance |
| | | 10 days | | History |

In the next step S6, based on the provided robot information, the operator judges as to whether each module should be continued to be used or at least one module should be detached (or exchanged). In the example of table 1, when the “Failure Prediction Information” is “Failure will occur within one day” or when “Failure Diagnosis Information” is “Abnormal,” it is necessary to immediately exchange the corresponding arm for another arm.

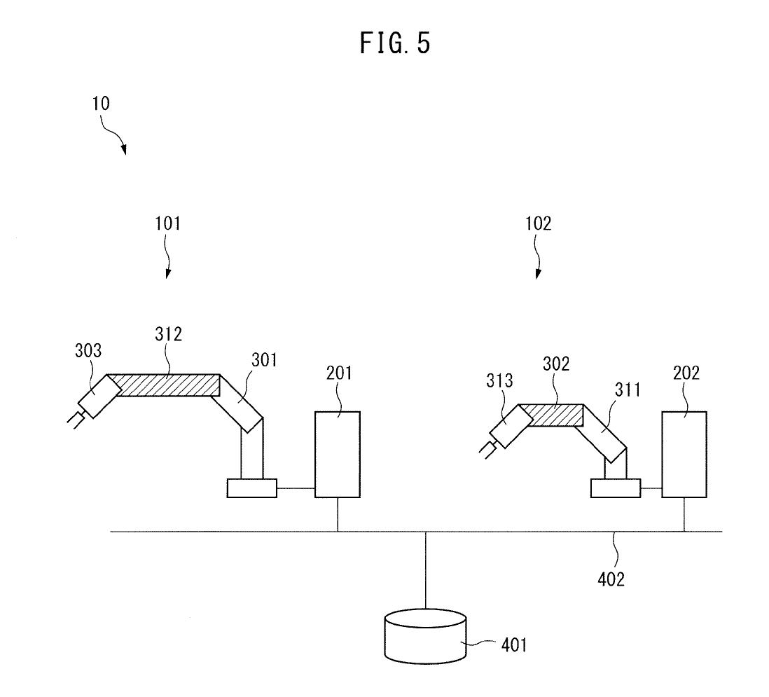

In this working example, it is assumed that one module should be detached from one robot and then attached to another robot. Concretely, as shown in FIG. 5, it is assumed that arm 302 is detached from robot 101, arm 312 is detached from robot 102, and then, arm 312 is attached to robot 101, and arm 302 is attached to robot 102.

In this case, as explained with respect to steps S2 and S3, the identifiable number of arm 312 newly attached to robot 101 is read by robot controller 201, and then the information regarding the failure prediction and/or maintenance of arm 312 is referred from database 401. Similarly, the identifiable number of arm 302 newly attached to robot 102 is read by robot controller 202, and then the information regarding the failure prediction and/or maintenance of arm 302 is referred from database 401.

As explained above, robot controller 201 accumulates the robot information (various information including the failure prediction and maintenance information) of arm 312 instead of arm 302 into database 401, and robot controller 202 accumulates the robot information of arm 302 instead of arm 312 into database 401. The robot controller or the other computer connected to database 401 can provide or output the robot information by using the accumulated information of each module in database 401.

As exemplified by working example 1 with respect to arms 302 and 312, even when the module is detached from one object (robot) and then attached to the other object (robot), the information associated with the operational status can be automatically and continuously stored or accumulated into database 401. Therefore, the appropriate robot information can be provided by referring to the information of the module by using robot information referring section 602.

Table 2 shows an example of the content provided or displayed in a tabular form on robot controller 201. As shown in table 2, the displayed content is changed since arm 302 attached to robot 101 is replaced with arm 312.

TABLE 2

| | | | Failure | |
|---|---|---|---|---|
| | | | Diag- | |
| | | Failure | nosis | Maintenance |
| Name of | Operational | Prediction | Infor- | History |
| Module | Status | Information | mation | Information |
| Arm 301 | 500 hours/month | Failure is | Normal | Component A |
| | | not predicted | | was exchanged |
| | | | | on ZZ/YY/20XX |
| Arm 312 | 400 hours/month | Failure is | Normal | Component B |
| | | not predicted | | was exchanged |
| | | | | on zz/yy/20xx |
| Arm 303 | 600 hours/month | Failure will | Normal | No |
| | | occur within | | Maintenance |
| | | 10 days | | History |

### Working Example 2

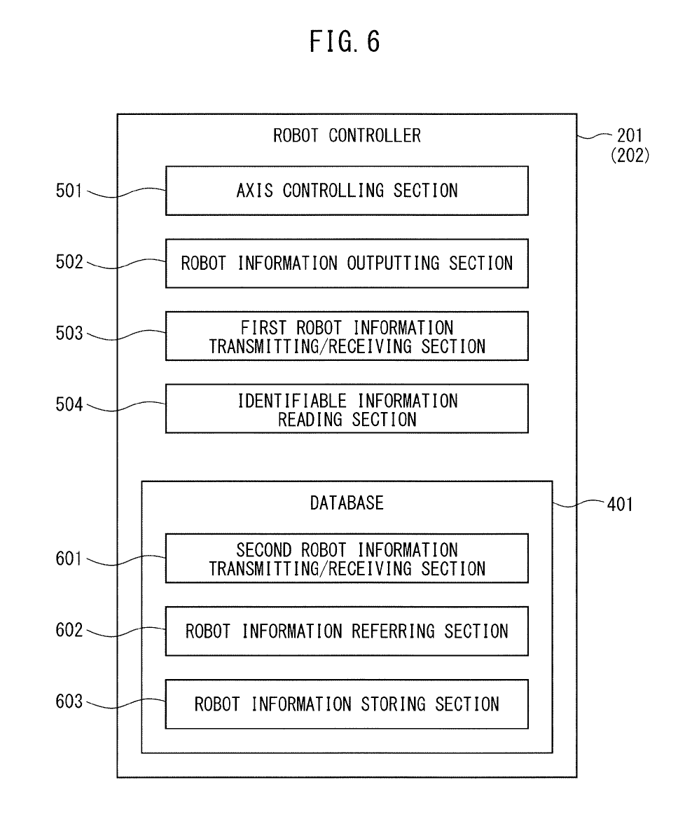

In above working example 1, database 401 is arranged as a unit independent from robot controller 201 or 202. On the other hand, in working example 2, database 401 may be provided to (e.g., contained in) at least one of robot controllers 201 and 202, as shown in FIG. 6. In other words, the robot controller may have the function of database 401. The other parts of the second working example may be the same as the first working example, unless otherwise noted, and thus a detailed explanation thereof will be omitted.

In working example 2, similarly to working example 1, when arm 302 is detached from robot 101 and then attached to 102, the robot information after arm 302 is attached to robot 102 is stored or accumulated in the database contained in robot controller 202. In this regard, the robot information before arm 302 is attached to robot 102, if required, can be obtained as described below.

First, robot controller 202 reads the identifiable information of arm 302, and then, refers to the robot information, associated with the read identifiable information, in the databases of all of the robot controllers connected to each other via the communication network. In working example 2, robot controller can refer to the robot information of arm 302 during being attached to robot 101, before being attached to robot 102, in the database contained in robot controller 201. In this way, the robot information of arm 302 before arm 302 is attached to robot 102 can be obtained. Therefore, the robot information of each module constituting the robot can be tracked or traced, even when the module is detached from one robot and attached to the other robot, and thus the tracked robot information can be timely provided to the operator, if required.

### Working Example 3

In the third working example as explained below, unlike the first or second working example, each module contains a non-volatile memory having (the function of) database 401. In the third working example, as shown in FIG. 1, arms 301, 302, 303, 311, 312 and 313 contain non-volatile memories 701, 702, 703, 711, 712 and 713, respectively, and each non-volatile memory has a database. The other parts of the third working example may be the same as the first or second working example, unless otherwise noted, and thus a detailed explanation thereof will be omitted.

In working example 3, it is not necessary to connect the robot controller to the communication network. The database of each non-volatile memory continuously stores or accumulates only the robot information of the module (arm) which contains the corresponding (own) non-volatile memory. Therefore, it is not necessary to associate the information stored in the database with the identifiable number of the module.

For example, when arm 302 is detached from robot 101, the information accumulated in the database contained in arm 302 is not lost. Then, when arm 302 is attached to robot 102, the robot information thereafter will be stored or accumulated in the database in arm 302, in addition to the robot information in the past.

Therefore, the database contained in arm 302 stores all information from when arm 302 is manufactured. Robot controller 202 can provide or output the robot information of arm 302, by referring to the stored robot information. Accordingly, the robot controller can trace the robot information of each module and timely provide it to the operator, if required, by referring to the robot information in the database contained in each module attached to the robot connected to the robot controller.

In the above working examples, the robot mechanical unit can be exchanged in units of modules, each module can be identified, and the unique identifiable information of each module can be utilized. By virtue of this, even when the module is detached from one robot and then attached to the other robot, the robot information, including at least one of the operational status, the failure prediction information, the failure diagnosis information and the maintenance history information of corresponding module and the effect of the operational status of the other module on the corresponding module, can be continuously stored or accumulated in the database. Further, by referring to the past information (history) of the module stored in the database, the robot information of the corresponding module can be easily provided to the operator, whereby the operator can appropriately judge as to whether each module should be exchanged, based on the provided robot information. Therefore, in the present disclosure, the production efficiency and/or availability ratio of the system including the modularized robot can be significantly improved.

According to the present invention, in the robot mechanical unit configured to be exchanged in units of modules, the information regarding the failure prediction and/or maintenance can be managed with respect to each module. Further, while the component configured as the module can be arbitrarily attached to or detached from the robot, the productional availability ratio can be improved.

While the invention has been described with reference to specific embodiments chosen for the purpose of illustration, it should be apparent that numerous modifications could be made thereto, by one skilled in the art, without departing from the basic concept and scope of the invention.

1. A robot system, comprising:
a robot mechanical unit constituted by a plurality of modules, each module having a unique identifiable information and being exchangeable;
a robot controller configured to control a motion of each axis of the robot mechanical unit;
a robot information storing section configured to store robot information including at least one of an operational status, failure prediction information, failure diagnosis information and maintenance history information of each module;
a reading section configured to read the unique identifiable information of the module;
a robot information referring section configured to refer to the stored robot information with respect to the module corresponding to the read unique identifiable information; and
a robot information outputting section configured to output the robot information with respect to each module of the robot mechanical unit.

2. The robot system as set forth in claim 1, wherein the robot information storing section is included in a database connected to a communication network connected to the robot system.

3. The robot system as set forth in claim 1, wherein the robot information storing section is included in a database provided to the robot controller.

4. The robot system as set forth in claim 1, wherein the robot information storing section is included in a database provided to a non-volatile memory provided to each module of the robot mechanical unit.

5. The robot system as set forth in claim 1, wherein the robot information provided to each module of the robot mechanical unit is accumulated information of the module with respect to all of robots to which the module is presently attached and was attached in the past.

6. The robot system as set forth in claim 1, wherein the robot information outputting section is a display device provided or connected to the robot controller.

7. A maintenance method for a robot system, the robot system including:
a robot mechanical unit constituted by a plurality of modules, each module having a unique identifiable information and being exchangeable; and
a robot controller configured to control a motion of each axis of the robot mechanical unit,
wherein the method comprising the steps of:
storing robot information including at least one of an operational status, failure prediction information, failure diagnosis information and maintenance history information of each module;
reading the unique identifiable information of the module;
referring to the stored robot information with respect to the module corresponding to the read unique identifiable information; and
outputting the robot information with respect to each module of the robot mechanical unit.
